(19) United States
(12) Patent Application Publication
(10) Pub. No.: US 2003/0198184 A1
(43) Pub. Date: Oct. 23, 2003

(54) Method of dynamically determining real-time multimedia streaming rate over a communications networks

(76) Inventors: Joe Huang, Parsippany, NJ (US); Phillip Gregory Sherwood, San Diego, CA (US); Chun-Jen Tsai, La Jolla, CA (US); Szu-Wei Wang, Pearl River, NY (US); Yuqi Yao, Morris Plains, NJ (US); Thomas Meng-Tao Zeng, San Diego, CA (US)

Correspondence Address: PACKETVIDEO CORP, SUITE 210, 10350 SCIENCE CENTER DR, SAN DIEGO, CA, 92121-1138, US

(21) Appl. No.: 09/945,020

(22) Filed: Aug. 31, 2001

(51) Int. Cl. H04L 1/00

(52) U.S. Cl. 370/231; 370/468

(57) ABSTRACT

The invention provides a method for a multimedia server to dynamically adjust the data rate that is streamed over an error-prone bandwidth-varying wireless network to a mobile multimedia client in a client-server architecture. The method enables multimedia applications to efficiently utilize the available (yet time-varying) wireless channel bandwidth and helps prevent interruption in the streaming due to client buffer underflow and packet loss due to network buffer overflow, hence significantly improving the multimedia streaming performance.

### BACKGROUND OF THE INVENTION

The present invention relates to the field of wireless multimedia communications, and more particularly, to a method of dynamically adjusting the multimedia data rate for streaming over an end-to-end communication network.

### DESCRIPTION OF THE RELATED ART

Multimedia communication through wireless interface allows a user to communicate from mobile locations in multiple formats, e.g., voice/audio, data, image, and full motion video. However, today's second-generation cellular telephony networks such as CDMA-IS95A (Code Division Multiple Access), TDMA-IS136 (Time Division Multiple Access), and GSM (Global System for Mobile), typically support data rate less than 15 kbps (kbits/sec), suitable for compressed speech, but too little for multimedia information. Since multimedia communication is envisioned to be a significant component of future wireless communication services, various two-and-half and third generation wireless standards and technologies such as GPRS (General Packet Radio Service), CDMA IS-95B, CDMA2000 1x, CDMA2000 1xEV (EVolution) and W-CDMA (Wideband CDMA), have been designed to have the capability of providing higher speed data services, ranging from more than 100 kbps (kbits/sec) to several Mbps (mbits/sec).

Future wireless multimedia applications will have to work over an open, layered, Internet-style network with a wired backbone and wireless extensions. Therefore, common protocols will have to be used for the transmission across the wireline and wireless portions of the network. Reliable delivery transport protocols, such as Transport Control Protocol (TCP) can introduce significant delay by re-transmitting data packets until they are acknowledged as correctly received. On the other hand, Real-Time Transport Protocol (RTP), as more fully discussed in Schulzrinne et al., “RTP: A transport protocol for real time applications.” Internet draft, draft-ietf-avt-rtp-new-07.ps, March, 2000, is specifically defined by Internet Engineering Task Force (IETF) to support real-time data delivery for multimedia applications. RTP is generally used in conjunction with UDP (User Datagram Protocol), which is a “best-efforts”, connectionless protocol. Moreover, RTP includes a sub-component know as Real-Time Control Protocol (RTCP), which is used to convey performance information between a server and a client. Compressed media of any kind, along with other data types, can be transported, multiplexed, and synchronized by using the services provided by the RTP/UDP/IP stack. This approach has a high potential to become an industry standard protocol for real-time data delivery for multimedia applications.

Real-time multimedia streaming enables users to view or listen to rich multimedia content soon after the end user begins receiving the streaming data, without having to download the whole multimedia file first. On the other hand, transmission of real-time multimedia streams is complicated compared to file download due to the delay-sensitive nature of the real-time data. For example, if the real-time data arrives after its due time relative to other portion of the multimedia presentation, the presentation will either be stalled until the right section comes in or suffer from distortion if the late data is simply discarded. This issue is most serious when the access medium is a wireless network.

Radio transmission over a wireless channel is highly prone to errors due to multi-path effects, shadowing, and interference. Link layer retransmissions that are commonly used in wireless communication systems to correct the corrupted data can result in high transmission delay and jitter. Secondly, the wireless channel bandwidth can vary significantly over time. The reason is that the amount of bandwidth that is assigned to a user can be a function of the signal strength and interference level that such user receives since more processing gain or heavier channel coding is needed to protect the data under low signal strength or high interference conditions. As a user travels through different parts of the cell with varying signal strengths due to radio wave propagation path loss and fading, different bandwidths may be dynamically assigned to the user. In addition, depending on the quality of service (QoS) capability of the wireless network, multi-user sharing of the wireless channel with heterogeneous data types can also lead to significant channel bandwidth variation. Lastly, data transmission can be interrupted completely depending on wireless network implementation, e.g., cell reselection/handoff process, resulting in transmission gaps ranging from a fraction of a second to several seconds. This unpredictability of available wireless channel bandwidth introduces high delay jitter for the multimedia streaming data.

To provide a margin for delivery jitter, multimedia streaming systems often delay start of playback at the beginning of the stream to build up a buffer of data (this buffer is often referred to as the jitter buffer). Since the data in the buffer must flow out at the predefined playtime, the jitter buffer must be continually refilled in order for the multimedia stream to continue to play without interruption. If the buffer empties completely and playback stalls, a condition known as underflow, it is necessary to refill the jitter buffer before playback can continue. The unpredictable stopping and starting of playback that results can seriously disrupt the user experience and limit the viability of multimedia distribution over wireless networks. Although automatic QoS control in wireless networks may help alleviate this problem in the future, it may take years before mature QoS control will be widely deployed commercially.

Another approach to the problem is to dynamically adjust the multimedia streaming quality and data rate in response to network conditions, henceforth termed “dynamic rate control”. Compared to approaches relying on QoS control (e.g., resource reservation and/or admission control), dynamic rate control approach has the advantage of better utilizing the available network resources and enhancing the inter-protocol fairness between TCP and non-TCP protocols (i.e., “TCP friendly”).

Fundamentally, dynamic rate control is facilitated by the nature of some existing multimedia applications, which may allow the media rate and quality to be adjusted over a wide range. A prominent example is the scalability features provided by the MPEG-4 (Motion Picture Experts Group) video coding standards, including temporal scalability, spatial scalability (including, SNR (signal-to-noise ratio) scalability), and FGS (fine-granularity scalability). A scalable encoder generates a bit-stream that allows decoding an appropriate subset of the bit-stream based on the available bandwidth and the capability of the decoder. As more bandwidth becomes available, more of the bit-stream can be delivered, resulting in a higher quality multimedia presentation.

A variety of dynamic rate control algorithms have been proposed for use in the wireline Internet. Most of these techniques regulate the streaming data rate at the server by detecting network congestion based on packet loss. Examples of such work can be found in Buss et al., “Dynamic QoS control of multimedia applications based on RTP,” Computer Communications, vol.19, no.1, pp.49-58, January 1996; Bolot et al., “Experience with rate control mechanisms for packet video in the Internet,” Computer Communication Review, vol. 28, no.1, January 1998; Sisalem et al., “The direct adjustment algorithm: A TCP-friendly adaptation scheme”, Quality of Future Internet Services Workshop, Berlin, Germany, Sep. 25-27, 2000; and Padhye et al., “A model based TCP-friendly rate control protocol,” Proc. International Workshop on Network and Operating System Support for Digital Audio and Video (NOSSDAV), Basking Ridge, N.J., June 1999. In order to be “TCP-friendly”, these schemes either use control algorithms similar to TCP or based the adaptation behavior on an empirical analytical model of TCP. Typically, the rate adjustment procedure follows an AIMD (Additive Increase, Multiplicative Decrease) principle. That is, the sender additively increases the rate when no loss is detected and multiplicatively decreases the rate when sufficient amount of loss is detected. Consequently, the rate adjustment basically follows a saw-tooth pattern and the multimedia presentation quality may not be very smooth.

In general, these schemes use packet loss as the main indicator of available network bottleneck bandwidth. However, regulating the send rate based on packet loss caused by network buffer overflow will tend to maximize the buffer occupancy and queuing delay at the bottleneck element of the network. In the case of wireless multimedia streaming, the wireless access network may very well be the bottleneck of the end-to-end network. Use of packet loss-based rate control in wireless networks with highly variable channel bandwidth tends to fill up the data buffers in the wireless access network and introduce significant delay in the multimedia streaming data, resulting in high probability in player buffer underflow and stalled playback. A second problem is that loss based rate control intentionally induce packet loss as they increase the data rate in the additive mode to explore available network bandwidth. These lost packets may be automatically retransmitted at the transport or application layer, resulting in high delay jitter. If lost packets are not retransmitted, the quality of the multimedia presentation will be degraded. A final problem is that packet loss in wireless networks can originate at multiple sources, including the air link as well as the wireless network buffer. Packet loss-based rate control may misinterpret the significance of packet loss under these circumstances and perform poorly as a result.

Recently, a few schemes have been proposed that use the total amount of buffered/queued data on the transmission path as a means to adjust the send rate. Yano et al., “A rate control for continuous media transmission based on backlog estimation from end-to-end delay,” http://www.cs.berkeley.edu/˜yano/pubs/corbed-pv99/; and Jacobs et al., “Real-time dynamic shaping and control for Internet video applications,” Workshop on Multimedia Signal Processing, Princeton, N.J., June, 1997, describe such schemes. Here, the basic goal is to control the total amount of data buffered in the network at a constant, desired level. However, simply trying to maintain a constant amount of data in the network buffer does not guarantee that the send rate can track the channel bandwidth variation effectively in a wireless environment with high bandwidth variation. Indeed, the work presented in Yano et al. only studies constant bandwidth scenarios. Moreover, neither buffer size control nor bandwidth tracking are performed very effectively using the algorithm proposed by Jacobs et al.

Another important issue of the buffer based dynamic rate control algorithms is the accuracy of the buffered data estimation. While Jacobs et al. do not address how the amount of buffered data can be estimated at all, Yano et al. use the round trip time (RTT) and the average throughput to perform the estimation. Unfortunately, the estimation method used by Yano et al. is not accurate for wireless streaming applications because the uplink delay, which can range from a fraction of a second to a few seconds in wireless systems, has not been taken into account, resulting in a significant overestimation of the buffered data. Lastly, a given buffer level setting for one multimedia stream is frequently not optimal for other multimedia streams. The issue of how to find the desired buffer level is not addressed in the prior art. Therefore, for streaming of multimedia over wireless networks, there exists a need for a method to effectively track the wireless channel bandwidth variation and at the same time control the amount of data buffered in the network to reduce the delay jitter and adjust to packet loss caused by bandwidth variations and network buffer overflow.

### SUMMARY OF THE INVENTION

The present invention involves a novel framework to dynamically adjust the streaming multimedia data rate to track network throughput variation, while also trying to maintain a target amount of data in the wireline/wireless network buffer to control delay jitter and avoid network buffer overflow. By defining a pair of user-definable tuning parameters, the framework allows modification of the rate control algorithms to focus more on tracking the network throughput variation or on maintaining a target amount of buffered data. The invention also supports dynamic adjustment of the tuning parameters to allow the algorithm to self-adjust its focus between bandwidth tracking and network buffer control, depending on the current estimation of the amount of buffered data.

### BRIEF DESCRIPTION OF THE DRAWINGS

The current invention provides a method of dynamically determining a streaming data rate in a communications network. Other features and advantages of the invention will be understood and appreciated by those of ordinary skill in the art upon consideration of the following detailed description, appended claims and accompanying drawings of preferred embodiments, where:

FIG. 1 is a simplified block diagram illustrating a communications network in which the method according to principles of the present invention is operable;

FIG. 2 is a simplified flowchart illustrating the present method;

FIGS. 3 and 4 are more detailed flowcharts illustrating the steps of FIG. 2; and

FIG. 5 is a graphical illustration of a dynamic data rate set point algorithm according to principles of the present invention.

### DETAILED DESCRIPTION

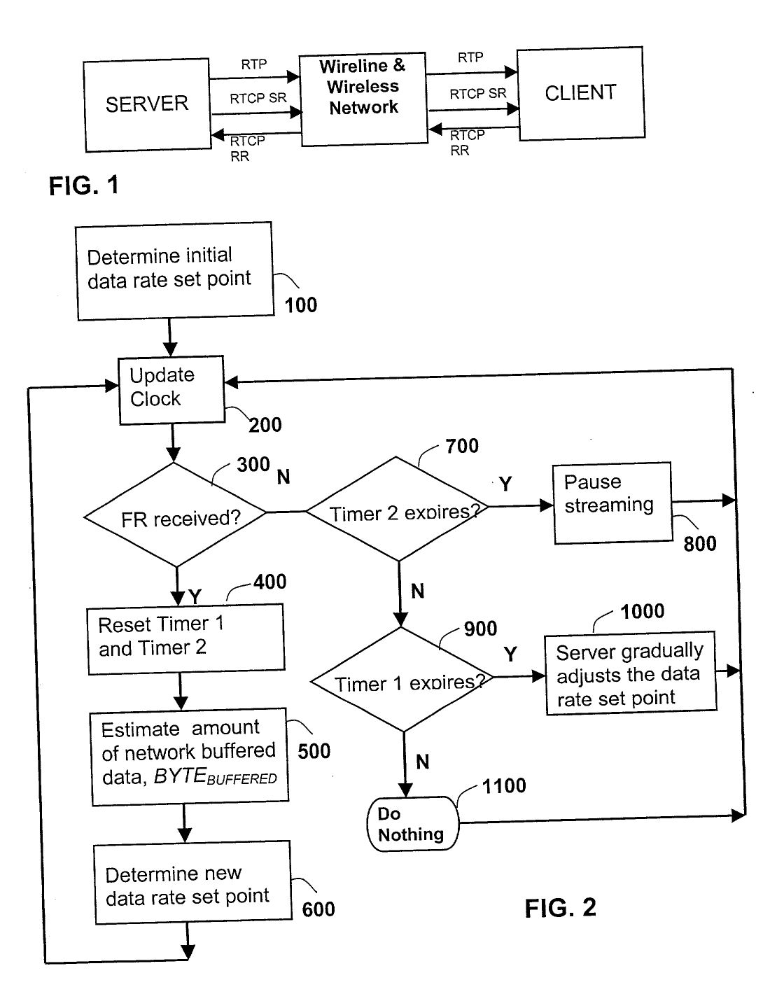

FIG. 1 is a simplified example of a communications network in which the method according to principles of the present invention is operable. In this environment, we assume that the transport protocol for multimedia data (e.g., RTP/RTCP protocol) contains a “periodic” feedback report (FR), which contains the necessary information to facilitate the rate control process (including, for example, information that can be used to estimate the channel throughput, network buffer occupation, and information regarding packet loss status). The feedback report may be sent from the client at a fixed interval (denoted T_{FR}), at a random interval (with mean T_{FR}) calculated based on a predefined probability distribution function, or upon the trigger of the first data packet arrival a fixed interval (target T_{FR}) after the send time of the last FR. The feedback information conveyed in the FR, along with the information available to the server itself, are used to determine the multimedia streaming data rate.

FIG. 2 shows a flowchart of the steps involved in dynamically determining and adjusting a data rate set point in accordance with principles of the present invention. An initial rate of streaming is determined 100 and the server will attempt to stream at that rate until the data rate set point is adjusted. Next a real time system clock is updated 200 and then it is determined whether a new FR has arrived 300. If a FR has arrived, a first and second timer, Timer 1 and Timer 2, respectively, are reset 400. The amount of data (in bytes) residing in the wireline/wireless network buffer (denoted BYTE_{BUFFERED}) is then estimated 500 for the instant that the server received the new FR from the mobile client. Next, the data rate set point is calculated 600 based on the estimated BYTE_{BUFFERED} for the particular received FR, from the previous step. Ideally, FRs should be received “periodically” (with reasonable variation) and the data rate set point can be determined accordingly by repeating steps 200-600, as illustrated in FIG. 2.

However, the transmissions typically are carried out over error prone networks, which can result in missing FRs. The present invention can account for this in the following manner. Referring back to step 300, if it was determined that the next FR has not been received, then it is determined how long it's been since the reception of the most recent FR. It is first determined if Timer 2 has expired 700, and if so, streaming is paused 800, and then the system returns to the step of updating the clock 200 and repeats the steps. However, if Timer 2 has not expired, it is determined whether Timer 1 has expired 900. If Timer 1 has expired, then the server will gradually change the data rate set point 1000, and then operation will continue by updating the clock 200, and repeating the above described process. If on the other hand, Timer 1 has not expired, then nothing is done 1100 and streaming will continue as it had been until the clock is updated 200 and the steps repeated. Thus, in accordance with the principles of the present invention, if it was determined that the next FR has not been received after a certain time since the reception of the most recent FR, i.e. Timer 1 expires, the server will gradually change the data rate set point. In addition, if the next FR has not been received after a second timer (Timer 2>Timer 1) expires, the system will pause streaming of data.

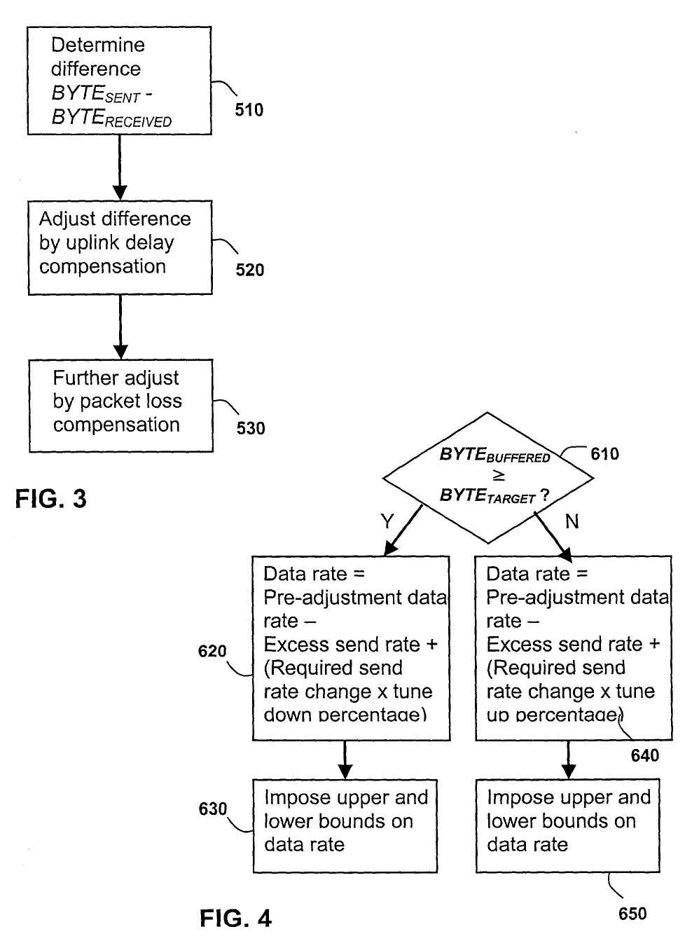

Referring now to FIG. 3, the process of estimating the amount of data in the network buffer is delineated as follows. The estimation is preferably based on the difference between the cumulative number of bytes sent from the server and that received by the client 510. This value is then adjusted by the bytes in transition during the uplink delay of the FR and is referred to as the uplink delay compensation 520. The uplink delay compensation can be computed from the estimated uplink delay and either the most recent instantaneous receive rate or a averaged receive rate calculated using the information reported in the FR. Alternatively, the compensation can also be estimated as the amount of data sent out by the server during the past estimated uplink delay period. Lastly, the packets that are lost due to network buffer overflow do not occupy network buffers and should be discounted 530. Thus, the estimated value is further adjusted by a packet loss compensation value. The packet loss compensation value can be computed as an accumulative amount of data lost from the beginning of the streaming which can be computed from the number of packets lost reported in the FR and either a short term or long term average packet size.

The steps involved in calculating the data rate set point 600 will now be described in further detail. Referring now to FIG. 4, in general, the streaming data rate set point is calculated as {a pre-adjustment streaming data rate set point} minus {an excess send rate (which is in effect the previous streaming data rate minus the most recent estimated received data rate)} plus {(the difference between BYTE_{BUFFERED} and a target byte count (termed BYTE_{TARGET}) divided by the (mean/target) FR interval) multiplied by a tuning parameter} 620, 640. The present invention provides for tune-up and tune-down parameters. Which tuning parameter utilized is determined based on whether BYTE_{BUFFERED}≧BYTE_{TARGET} 610. Finally, an upper and lower bound is imposed on the calculated data rate 630, 650. Here, BYTE_{TARGET} can be determined on a per stream basis by the multimedia server based on multimedia source encoding rate, client jitter buffer depth, and wireless network characteristics. In a preferred embodiment, the value of BYTE_{TARGET} is proportional to the product of the encoding source rate and the client jitter buffer depth. The proportional “scaling constant” can be determined for each type of wireless network separately.

The pair of tuning parameters, denoted TUNE_UP % and TUNE_DOWN %, provide a transition between the throughput tracking and network buffer size control (TUNE_UP % is used when BYTE_{BUFFERED} is lower than BYTE_{TARGET} and TUNE_DOWN % is used when BYTE_{BUFFERED} is higher than BYTE_{TARGET}). The fact that this framework allows TUNE_UP % and TUNE_DOWN % to be designed separately gives the designer room to customize the rate control algorithm. One may want to choose TUNE_UP %>TUNE_DOWN % to aggressively explore the available channel bandwidth or one may choose the opposite to reduce the probability of network buffer overflow and player buffer underflow. Moreover, when TUNE_UP % and TUNE_DOWN % are close to 100%, the algorithm will tryto maintain a “constant” network buffer size. On the other hand, when TUNE_UP % and TUNE_DOWN % are close to 0%, the algorithm will shift gear to track the network throughput. The reasons are explained as follows:

First note that the excess send rate, or the previous streaming data rate minus the most recent estimated received data rate, is conceptually equivalent to the increase in the BYTE_{BUFFERED} during the last FR interval divided by the last FR interval. Secondly, when TUNE_UP % and TUNE_DOWN % are close to 100%, the combination of the current BYTE_{BUFFERED} and the increase of BYTE_{BUFFERED} during the last FR interval gives a predicted value of BYTE_{BUFFERED} if both network throughput and streaming data rate were to remain the same for the next FR interval. Therefore, adding to the pre-adjustment streaming data rate set point a value equal to the difference between BYTE_{TARGET} and the predicted BYTE_{BUFFERED} divided by the (mean/target) FR interval ideally produces the desired target buffered byte count in the next FR interval.

On the other hand, when TUNE_UP % and TUNE_DOWN % are close to 0% (i.e., ignoring the effect of the third term), the pre-adjustment streaming data rate set point minus the excess send rate closely follows the wireline/wireless network throughput. The reason is that the pre-adjustment streaming data rate set point basically cancels the previous streaming data rate, leaving only the most recent estimated received data rate. Hence the proposed scheme tracks the network throughput variation. Note that, in an alternative embodiment, we can simply use the most recent estimated received data rate to replace the pre-adjustment streaming data rate set point minus the excess send rate, although the buffer control is more accurate with the preferred embodiment.

Our studies show that setting TUNE UP % and TUNE DOWN % too high or trying to control the BYTE_{BUFFERED} too hard prevents the server from tracking the throughput variation smoothly and can result in jerky rate adjustment. On the other hand, setting TUNE UP % and TUNE DOWN % too low weakens server's ability to control the network buffer size and can result in player rebuffering and/or packet loss. Moreover, although tracking the network throughput effectively normally indicates that wireless channel bandwidth is efficiently utilized, this is not always the case. For example, when the streaming data rate is sufficiently lower than the available channel bandwidth, network buffer will not accumulate and the measured throughput will follow the streamed data rate, which is lower than the available bandwidth. In this case, by tracking the network throughput alone, multimedia applications will not be able to fully explore the available bandwidth and provide the best performance.

For the reasons above, the values of TUNE_UP % and TUNE_DOWN % need to be carefully tuned to properly balance between throughput tracking and buffer size control. Within the scope of this invention, these two values can be determined either statically or dynamically. In the static case, TUNE_UP % and TUNE_DOWN % are simply a predefined set of constants. In the dynamic case, the values of TUNE_UP % and TUNE_DOWN % are determined based on the status of BYTE_{BUFFERED} relative to BYTE_{TARGET}. In general, the more BYTE_{BUFFERED} falls below the target buffer size, the higher the value of TUNE_UP % should be used and the more BYTE_{BUFFERED} exceeds the target buffer size, the higher the value of TUNE_DOWN % should be used. In the design of a specific algorithm, the values of the tuning parameters can be changed based on a set of buffer thresholds BYTEᵢ (i=1 . . . M); different tuning parameter values are used when BYTE_{BUFFERED} falls into different regions partitioned by the thresholds, i.e., TUNE_UP %=TUNE_UP %_i and TUNE_DOWN %=TUNE_DOWN %_i when (BYTEᵢ₋₁<BYTE_{BUFFERED}<BYTEᵢ). As a simple example, one can first choose a set of values for TUNE_UP % and TUNE_DOWN % as default. When BYTE_{BUFFERED} falls below a minimum threshold (BYTEₘᵢₙ), a higher value of TUNE_UP % can be used to promote a better utilization of the available channel bandwidth. On the other hand, when BYTE_{BUFFERED} reaches beyond a maximum threshold (BYTEₘₐₓ), a higher value of TUNE_DOWN % can be used to prevent excessive packet queuing delay and network buffer overflow.

Another way to implement the dynamic adjustment concept is to define the TUNE_UP % and TUNE_DOWN % as a continuous function of BYTE_{BUFFERED}, therefore, changing the tuning parameters every time a new BYTE_{BUFFERED} is estimated. For example, let

TUNE_UP %={a+(1−a)[1/−(BYTE_{BUFFERED}/BYTE_{TARGET})^{b}]}×100% BYTE_{BUFFERED}<BYTE_{TARGET} Eqn. 1

TUNE_DOWN %={c+(1−c)[1−(BYTE_{TARGET}/BYTE_{BUFFERED})^{d}]}×100% BYTE_{BUFFERED}>BYTE_{TARGET} Eqn. 2

where a, b, c, d (with 0<a, c<1 and b, d>0) are design parameters. Note that a hybrid algorithm involving both thresholds and continuous function can certainly be designed within the proposed framework.

The description in previous paragraphs tacitly assumes that the feedback report (FR) can be “periodically” (with reasonable variation) delivered to the server to facilitate rate set point update. However, since FR is sent over the error-prone wireless channels, it is possible that sometimes FR may be lost. Moreover, when a client travels behind a building or into a radio coverage hole, the radio signal between the base station and the mobile client will be blocked, resulting in a transmission gap. If the transmission gap is sufficiently long, the multimedia call for the shadowed client may be disconnected automatically or by the user intentionally. Since the uplink channel is blocked, the server is not aware that the client has been disconnected and continues to stream the multimedia data to the disconnected mobile client. Once the client comes out of the shadow, it may try to reconnect and start a new streaming session. In this case, the server may send two multimedia streams to the same client, jamming the available bandwidth and resulting in poor performance. On the other hand, if for some reason, the multimedia call can still be maintained during a long transmission gap, the amount of data in the wireless network buffer will increase very fast (since the effective channel throughput is very low) and may result in significant packet loss due to network buffer overflow. This scenario can occur in the cell reselection/hand-off process in some wireless networks when a mobile client moves from one base station to another.

To avoid building up too many data bytes in the wireline/wireless network buffers due to lost FRs, the server can gradually decrease the data rate set point if the next FR has not been received within a specified period. In addition, if the server does not receive FR over an extended period of time due to the presence of a long transmission gap, then the server can pause the streaming (i.e., data rate set point=0) until either a new FR is received or eventually a timeout is reached when the server tears down the stream.

When streaming is first resumed after pause, the streaming data rate set point can still be calculated based on the proposed framework. Note that, in this case, both the pre-adjustment streaming data rate set point and the previous streaming data rate are zero, therefore, the pre-adjustment streaming data rate set point minus the excess send rate becomes the most recent estimated received data rate.

A preferred embodiment of carrying out the method in accordance with principles of the present invention will now be described in further detail. In the preferred embodiment, we assume that the multimedia server utilizes RTP/RTCP on top of UDP/IP for data delivery. The feedback information conveyed in the RTCP packets, along with the information available to the server itself, are used to determine the multimedia streaming data rate. In particular, we use the RTCP receiver report (RR) as the example feedback report mechanism in the following description. In this case, the feedback report interval (T_{FR}) is termed T_{RTCP}. The network diagram associated with this preferred embodiment is given in FIG. 1.

Here, SR denotes the sender report defined in the RTP/RTCP protocol.

As described hereinabove, BYTE_{BUFFERED} is estimated based on the RTCP reported information, and the estimated one-way uplink delay (UD), the server can calculate the estimated amount of data buffered in the wireline/wireless network (BYTE_{BUFFERED}), at the instant when the server received the n^{th} RTCP receiver report T_{R}(n) as follows:

BYTE_{BUFFERED}(n)=max(0, BYTE_{SENT}(0, T_{R}(n))−BYTE_{REC}(0, T_{S}(n))−BYTE_{UP}_{_{—}}_{COMP}(n)−BYTE_{LOST}(0, n)). Eqn. 3

BYTE_{UP}_{_{—}}_{COMP}(n) is the uplink delay compensation, which can be calculated as:

BYTE_{UP}_{_{—}}_{COMP}(n)=UD(n)*RATE_{REC}(T_{S}(n−1),T_{S}(n))) Eqn. 4

i.e., estimated byte count that the client should have received during the one-way uplink delay period. Here,

RATE_{REC}(T_{S}(n−1),T_{S}(n))=[BYTE_{REC}(T_{S}(n−1),T_{S}(n))/(T_{S}(n)−T_{S}(n−1))] Eqn. 5

is the received data rate between RR n−1 and n.

In an alternative embodiment, the uplink delay compensation can be calculated as:

BYTE_{UP}_{_{—}}_{COMP}(n)=BYTE_{SENT}(T_{R}(n)−UD(n),T_{R}(n))), Eqn. 6

Which is the number of bytes sent from the server between time T_{R}(n)−UD(n) and T_{R}(n).

BYTE_{LOST} in Eqn. 3 can be calculated as:

BYTE_{LOST}(0,n)=BYTE_{LOST}(0, n−1)+PL(n−1,n)*[BYTE_{SENT}(T_{R}(n−1),T_{R}(n))/P_{SENT}(T_{R}(n−1),T_{R}(n))] Eqn. 7

and is the estimated byte count for the number of packets lost up to n^{th} RR, where

T_{R}(n) is the instant when the server received the n^{th} RTCP RR;

T_{S}(n) is the send client time of n^{th} RR when the n^{th} RTCP RR is sent by the client (the index “n” does not include lost RTCP reports);

UD(n) is the estimated one-way uplink delay upon the reception of n^{th} RTCP RR;

BYTE_{SENT}(0, T_{R}(n)) is the accumulative number of bytes sent from the server up to the reception of n^{th} RR;

BYTE_{REC}(0, T_{S}(n)) is the accumulative number of bytes received by the client up to the time of sending of n^{th} RR;

BYTE_{SENT}(T_{R}(n−1),T_{R}(n)): is the number of bytes sent from the server between receiving RR n−1 and n;

BYTE_{REC}(T_{S}(n−1),T_{S}(n)) is the number of bytes received by the client between sending RR n−1 and n;

PL(n−1n) is the number of packets lost between RR n−1 and n. PL(n−1,n) can be determined as PL(n−1,n)=PL_{CUM}(n)−PL_{CUM}(n−1), where PL_{CUM}(n) is the cumulative number of packets lost reported in n^{th} RR; and

P_{SENT}(T_{R}(n−1),T_{R}(n)): is the number of packets sent from the server between receiving RR n−1 and n.

In the above described calculation, the value of the uplink delay can be static (determined empirically based on measurements) or can be dynamically estimated.

The following is a preferred technique for estimating the uplink delay. Assume that the client and server clock (T_{client} and Tₛₑᵣᵥₑᵣ) are off by ΔT. That is,

Tₛₑᵣᵥₑᵣ=T_{client}−ΔT Eqn. 8

When the n^{th} RTCP RR messages are sent from client to server during the stream, each will experience a new uplink delay, UD(n)

UD(n)=T_{R}(n)−T_{S}(n)+ΔT Eqn. 9a

where T_{R}(n) is the server time stamp when the n^{th} RTCP receiver report is received by the server and T_{S}(n) is the client time stamp when the n^{th} RTCP receiver report is sent by the client (the value “n” does not include lost RTCP reports). Since we can also write UD(n−1)=T_{R}(n−1)−T_{S}(n−1)+ΔT, an iterative relation of the one-way uplink delay can be written as

UD(n)=UD(n−1)+ΔUD(n) Eqn. 9b

where ΔUD(n)=(T_{R}(n)−T_{R}(n−1))−(T_{S}(n)−T_{S}(n−1)) is the uplink jitter.

The initial uplink delay can be estimated as a fraction of the round trip time (RTT). Estimation of RTT using RTCP sender and receiver reports is known to those skilled in the art and can be found in Schulzrinne et al.

UD(1)=UPLINK_DELAY %*RTT for n=1,

where UPLINK_DELAY % is a predefined parameter, the value of which can be determined empirically from field test experience. Moreover, the uplink delay at any instance should not be less than 0, nor should it be larger than the round trip time RTT. Therefore, we have

UD(n)=min(RTT, max(UD(n−1)+ΔUD(n), 0)) for n>1 Eqn. 9c

Turning to the data rate set point, a preferred method of calculating the data rate set point will now be described. Let BYTE_{TARGET} be the target for the total buffered byte count between the server and the client (user defined) and RATE_{SETPOINT} be the current data rate set point used by the server. The server calculates the new data rate set point when a RTCP report is received as follows:

For n=1, (start of streaming)

RATE_{SETPOINT}(0)=RATE_{INITIAL}

where RATE_{INITIAL} is the data rate set point determined by server at start of streaming (server calculation).

For n>=1,

For n>=,

If BYTE_{BUFFERED} (n) >=BYTE_{TARGET},then

| | |
|---|---|
| RATE_{SETPOINT}(T_{R}(n)) = RATE_{SETPOINT}(T_{R}(n)−δ) − RATE_{EXCESS}(n) | Eqn. 10a |

+ TUNE_DOWN%(n) * RATE_{REQ}(n);

but, if BYTE_{BUFFERED} (n)<BYTE_{TARGET}, then

| | |
|---|---|
| RATE_{SETPOINT}(T_{R}(n)) = RATE_{SETPOINT}(T_{R}(n)−δ) − RATE_{EXCESS}(n) | Eqn. 10b |

+ TUNE_UP%(n) * RATE_{REQ}(n),

where RATE_{SETPOINT}(T_{R}(n)−δ) is the pre-adjustment streaming data rate set point and T_{R}(n)−δ represents the time instant right before the server receives the n^{th} RTCP receiver report (T_{R}(n)).

RATE_{EXCESS} in Eqns. 10 above is the current excess send rate (i.e., the amount the send rate exceeds the receive rate, including packet loss),and can be calculated as:

RATE_{EXCESS}(n)=[BYTE_{BUFFERED}(n)−BYTE_{BUFFERED}(n−1)]/[T_{S}(n)−T_{S}(n−1)]

Additionally, RATE_{REQ} is the required send rate change to achieve the target network buffer size in the next RTCP interval, and is preferably calculated as:

RATE_{REQ}(n)=[BYTE_{TARGET}−BYTE_{BUFFERED}(n)]/T_{RTCP}.

BYTE_{TARGET} is determined on a per stream basis by the multimedia server based on multimedia source encoding rate (RATE_{SOURCE}), client jitter buffer depth (BUFFER_{CLIENT}), and wireless network characteristics. An example implementation is BYTE_{TARGET}=SCALE_{TARGET}*RATE_{SOURCE}*BUFFER_{CLIENT}, where SCALE_{TARGET} is a predefined scaling coefficient, the value of which can vary with wireless network characteristics.

As discussed hereinabove, the value of the tuning parameters TUNE_UP % and TUNE_DOWN % can be dynamically determined based on minimum and maximum buffer size thresholds, BYTE_{TUNE}_{_{—}}_{MIN} and BYTE_{TUNE}_{_{—}}_{MAX}, where BYTE_{TUNE}_{_{—}}_{MIN}<BYTE_{TARGET}<BYTE_{TUNE}_{_{—}}_{MAX}. In the preferred embodiment,

if BYTE_{BUFFERED > BYTE}_{TUNE}_{_{—}}_{MIN}

then TUNE_UP% = TUNE_UP%_LOW
else TUNE_UP% = TUNE_UP%_HIGH; and

if BYTE_{BUFFERED} < BYTE_{TUNE}_{_{—}}_{MAX}

then TUNE_DOWN% = TUNE_DOWN%_LOW
else TUNE_DOWN% = TUNE_DOWN%_HIGH.

Finally, it is preferable to impose an upper bound and lower bound on the streaming rate set point. Thus, we have:

RATE_{SETPOINT}(T_{R}(n))=max(RATE_{MIN}, min(RATE_{MAX}, RATE_{SETPOINT}(T_{R}(n)))

where

RATE_{MAX} is the maximum data rate set point settable by server (determined by server based on multimedia source encoding range and/or wireless network capability), and

RATE_{MIN} is the minimum data rate set point settable by server (determined by server based on multimedia source encoding range and/or wireless network capability).

In addition to the above discussed factors, missing RTCP receiver reports need to be addressed in determining the data rate set point. If all RTCP reports are received by the server correctly and have similar uplink delays, then ideally the data rate set point will remain constant between two consecutive RTCP reports, i.e., RATE_{SETPOINT}(T_{R}(n)−δ)=RATE_{SETPOINT}(T_{R}(n−1)). However, since RTCP receiver reports are sent over the unreliable UDP/IP channel via error-prone wireless networks, it is possible that several consecutive RTCP receiver reports may be lost (i.e., not received by the server). In order to avoid building up too many bytes in the wireline/wireless buffers due to the missing RTCP reports, the server can reduce the data rate set point gradually according to the following algorithm.

The server sets up a timer (denoted TIMER) for each streaming session. At time 0 (start of streaming), the server resets TIMER to zero. The server then resets TIMER to zero when a RTCP report is received at the expected time (i.e., at T_{R}(n)). When the TIMER reaches k*T_{RTCP} and every T_{RTCP} increment after k*T_{RTCP} (i.e., m*T_{RTCP} for m=k+1,k+2, . . . ), the server reduces the data rate set point as follows:

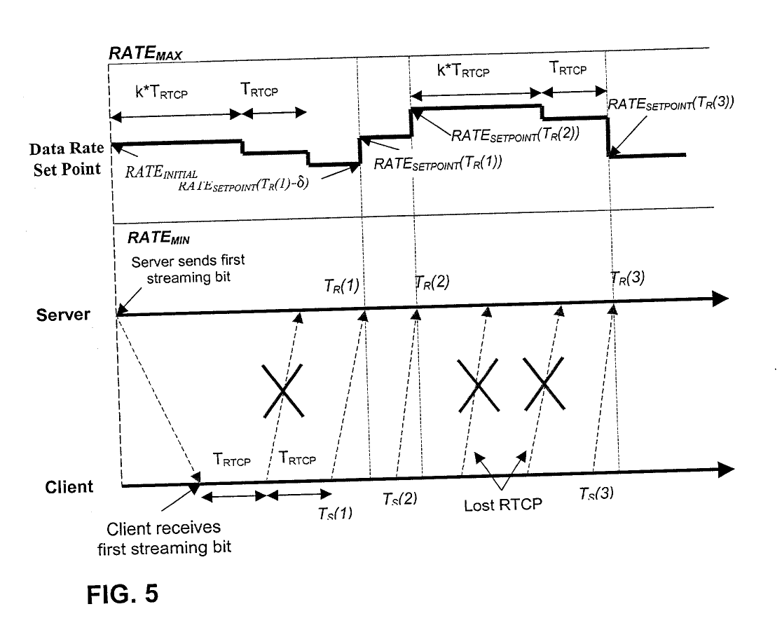

RATE_{SETPOINT}(after)=RATE_{SETPOINT}(before)−RATE_DELAY %*(RATE_{SETPOINT}(before)−RATE_{MIN}) Eqn. 11

where RATE_DELAY % is a user-adjustable constant (from 0% to 100%) defined by the server. Note that, due to the rate set point reduction, RATE_{SETPOINT}(T_{R}(n)−δ) will be smaller than RATE_{SETPOINT}(T_{R}(n−1)) whenever T_{R}(n)−T_{R}(n−1)>k*T_{RTCP}. Referring to FIG. 5, an exemplary graphical illustration of the dynamic data rate set point reduction process according to principles of the present invention is provided. Moreover, if the server does not receive any RR from the client for a certain period, T_{PAUSE}(>k*T_{RTCP}) seconds, the server can pause streaming. The reception of a first new RR will trigger the server to restart streaming. Otherwise, streaming will be discontinued after missing RRs for a total period of T_{STOP}(>T_{PAUSE}) seconds. This condition constitutes a timeout. The values of k, T_{PAUSE} and T_{STOP} are predefined.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. The disclosures and the description herein are purely illustrative and are not intended to be in any sense limiting. It is intended that the scope of the invention be defined by the claims appended hereto and their equivalents.

What is claimed is:

1. A method of dynamically determining a multimedia streaming data rate between multiple points in a communications network in which one or more points send data, servers, and one or more points receive data, clients, the method comprising the steps of:
estimating an amount of data buffered in the network, BYTE_{BUFFERED}, at a time a feedback report, FR, is received from the client; and
calculating a streaming data rate set point based on the estimated BYTE_{BUFFERED} and other information from the server.

2. The method of claim 1, wherein the step of estimating BYTE_{BUFFERED} comprises:
determining the difference between an accumulative number of bytes sent from the server and an accumulative number of bytes received by the client;
adjusting the determined difference by an uplink delay compensation value; and
adjusting the determined difference by an estimated amount of accumulative packets lost.

3. The method of claim 2, wherein the uplink delay compensation value is computed as the amount of data sent out by the server during a most previous uplink delay period.

4. The method of claim 2, wherein the uplink delay compensation value is computed from an estimated uplink delay and either a most recent instantaneous receive rate or an averaged receive rate calculated from the information reported in FR.

5. The method of claim 2, wherein the value of the uplink delay can be static or can be dynamically estimated.

6. The method of claim 5, wherein a dynamic determination of the uplink delay comprises the steps of:
determining the initial value based on initial round trip time, RTT, estimation;
iterative correction based on measured uplink jitter; and
setting an upper bound and lower bound.

7. The method of claim 2, wherein the packet loss compensation value is computed as the accumulative amount of data bytes lost from the beginning of the streaming.

8. The method of claim 2, wherein the packet loss compensation value is computed from the number of packets lost reported in the FR and either a short term or long term average packet size.

9. The method of claim 1, wherein the other information includes any combination of a pre-adjustment data rate set point, a target byte count, BYTE_{TARGET}, a most recent estimated received data rate, a previous server streaming data rate, an excess send rate, a required send rate change and a tuning parameter.

10. The method of claim 9, wherein the step of calculating the streaming data rate set point includes:
calculating the streaming data rate set point as the most recent estimated received data rate plus the required send rate change multiplied by the tuning parameter.

11. The method of claim 9, wherein the step of calculating the streaming data rate set point includes:
calculating the streaming data rate set point as the pre-adjustment data rate set point minus the excess send rate plus the required send rate change multiplied by the tuning parameter.

12. The method of claim 9, wherein the step of calculating the streaming data rate set point further includes imposing an upper and lower bound on the data rate set point.

13. The method of claim 12, wherein the upper and lower bounds imposed on the data rate set point are determined by the server based on a multimedia source encoding range or capabilities of the communications network.

14. The method of claim 13, wherein the upper and lower bounds imposed on the data rate set point are determined on a per stream basis by the server.

15. The method of claim 9, wherein the received data rate is calculated as the bytes received within a period between receiving a last and current FR divided by a FR report interval.

16. The method of claim 9, wherein the required send rate change is calculated as the difference between BYTE_{TARGET} and BYTE_{BUFFERED} divided by a FR report interval.

17. The method of claim 9, wherein the excess send rate is calculated as the previous server streaming data rate minus the most recent estimated received data rate.

18. The method of claim 9, wherein the excess send rate is calculated as the estimated BYTE_{BUFFERED} change within a period between receiving a last and a current FR divided by a FR report interval.

19. The method of claim 9, wherein the tuning parameter is determined based on a comparison between BYTE_{BUFFERED} and BYTE_{TARGET}.

20. The method of claim 9, wherein BYTE_{TARGET} is determined by the server based on a multimedia source encoding rate, a client jitter buffer depth, or characteristics of the communications network.

21. The method of claim 20, wherein BYTE_{TARGET} is determined on a per stream basis by the server.

22. The method of claim 9, wherein the tuning parameter is user definable so as to customize the data rate set point calculation process.

23. The method of claim 22, wherein the data rate set point calculation process is customized in order to efficiently utilize an available bandwidth of the communications network.

24. The method of claim 9, wherein the tuning parameter can be determined either statically or dynamically.

25. The method of claim 24, wherein a static determination of the tuning parameter comprises setting the tuning parameter as a predefined set of constants.

26. The method of claim 24, wherein a dynamic determination of the tuning parameter comprises defining the tuning parameter based on a set of buffer threshold values.

27. The method of claim 24, wherein a dynamic determination of the tuning parameter comprises defining the tuning parameter as a function of BYTE_{BUFFERED}.

28. The method of claim 1 wherein the method further comprises steps of:
gradually changing the data rate set point by the server if a next FR is not received from the client at an expected time; and
if the server does not receive FR over an extended period of time due to the presence of a long transmission gap, then pausing the streaming until either a new FR is received or eventually a timeout is reached, and when streaming is first resumed after pausing, the streaming data rate set point is calculated as a most recent estimated receive data rate plus a required send rate change multiplied by a tuning parameter.

29. The method of claim 28, wherein the step of gradually changing the data rate set point includes gradually increasing the data rate set point.

30. The method of claim 28, wherein the step of gradually changing the data rate set point includes gradually decreasing the data rate set point.

31. The method of claim 30, wherein the step of gradually decreasing the data rate set point includes:
calculating a decreased data rate set point as an immediately prior data rate set point minus a scaled difference between the prior data rate set point and a minimum data rate set point.

32. The method of claim 31, wherein the difference between the prior data rate set point and the minimum data rate set point is scaled by a rate delay parameter which is an adjustable percentage value defined by the server.

33. The method of claim 1, wherein the communications network utilizes Real-Time Transport Protocol/Real-Time Control Protocol (RTP/RTCP) on top of User Datagram Protocol/Internet Protocol (UDP/IP) for data delivery.

34. The method of claim 1, wherein the communications network is a wireless network.

35. The method of claim 1, wherein the FR may be sent from the client at a fixed interval, T_{FR}, at a random interval having a mean T_{FR} calculated based on a predefined probability distribution function, or upon the trigger of a first data packet arrival a fixed interval, target T_{FR}, after the send time of the last FR.

36. A method for dynamically adjusting a data transmission rate between two points in a communications network, the method comprising steps of:
estimating an amount of data buffered in the network, BYTE_{BUFFERED}, at a time a feedback report, FR, is received from a client;
calculating a data rate set point based on the estimated BYTE_{BUFFERED} and other information from a server; and
imposing an upper and lower bound on the data rate set point, to establish minimum and maximum data rate set points, respectively.

37. A method for dynamically adjusting a multimedia data rate between two points in a communications network, the method comprising steps of:
estimating an amount of data buffered in the network, BYTE_{BUFFERED}, at a time a feedback report, FR, is received from the client;
calculating a data rate set point based on the estimated BYTE_{BUFFERED} and other information from the server;
imposing an upper and lower bound on the data rate set point, to establish minimum and maximum data rate set points, respectively; and
gradually changing the data rate set point by the server if a next FR has not been received from the client within a specified time period.
